(19) United States
(12) Patent Application Publication
(10) Pub. No.: US 2026/0295459 A1
(43) Pub. Date: Oct. 1, 2026

(54) CASCADED AXIAL-FLOW SALTWATER CRYSTALLIZATION SYSTEM AND USE METHOD THEREOF

(71) Applicant: Xi'an University of Technology, Xi'an (CN)

(72) Inventors: Weiyi MU, Xi'an (CN); Mingjiang DENG, Xi'an (CN); Quanjiu WANG, Xi'an (CN); Hongbo LING, Xi'an (CN); Qianming Ma, Xi'an (CN)

(21) Appl. No.: 19/568,729

(22) Filed: Mar. 16, 2026

(30) Foreign Application Priority Data
Mar. 26, 2025 (CN) 202510366927.5

(51) Int. Cl. B01D 9/00

(52) U.S. Cl. CPC B01D 9/0031; B01D 9/005; B01D 9/0063; B01D 2009/0086

(57) ABSTRACT

A cascaded axial-flow saltwater crystallization system and a use method thereof are provided. The system includes a photothermal salt collection module and a Fresnel salt collection module disposed on a support frame side by side. A salt outlet of the photothermal salt collection module is connected to a salt inlet of the Fresnel salt collection module through a solenoid valve. Axial central lines of the photothermal salt collection module, the solenoid valve, and the Fresnel salt collection module are coaxial. The photothermal salt collection module, the solenoid valve, and the Fresnel salt collection module together form a cascaded axial-flow structure. A first spiral scraper assembly is disposed inside a first heat collection tube to push materials into a second heat collection tube. A second spiral scraper assembly is disposed inside the second heat collection tube to push the materials to a salt discharge port.

### CROSS-REFERENCE TO RELATED APPLICATION

This application claims priority to Chinese Patent Application No. 202510366927.5, filed on Mar. 26, 2025, which is herein incorporated by reference in its entirety.

### TECHNICAL FIELD

The disclosure relates to the technical field of saltwater crystallization treatment, and more particularly to a cascaded axial-flow saltwater crystallization system and a use method thereof.

### BACKGROUND

Saltwater can cause soil salinization and acid-alkalization, which endangers growth of plants, reduces quality of crops, and leads to environmental water pollution and ecological damage. In China, the saltwater is mainly distributed in northwestern arid regions and eastern coastal areas. A total amount of the saltwater far exceeds that of freshwater. Saltwater resources are abundant, which have great potential for development and utilization. Currently, the saltwater has been utilized to a certain extent in related art, such as producing salt, alkali, and chlorine from the saltwater, and methods for producing the salt, alkali, and chlorine include a solar salt-making method, a boiling method, a lake salt-extraction method, an evaporation pond method, an electrolysis method, and an ion-exchange method. Compared with other methods, an evaporation method is to use industrial means to heat the saltwater and to utilize thermal energy to promote evaporation of water in the saltwater. This method has high energy consumption and low efficiency. In nature, solar resources can transfer the thermal energy through radiation and are widely available. Moreover, related technologies such as concentrated solar heat collection, selective light-absorbing membrane heat collection, vacuum heat collection, and lens heat collection are relatively mature. When these technologies can be effectively combined, an innovative heat collection method driven by a natural force of solar radiation energy can be proposed, and a new type of saltwater salt collection system driven by this natural force can be developed, which will provide innovative theories and technologies for resource-based utilization of the saltwater resources.

Therefore, it is very necessary and urgent to develop a cascaded axial-flow saltwater crystallization system.

### SUMMARY

The disclosure aims to provide a cascaded axial-flow saltwater crystallization system and a use method thereof, to thereby solve a problem of high energy consumption and low efficiency of saltwater evaporation crystallization methods in the art.

A technical solution used by the disclosure is the cascaded axial-flow saltwater crystallization system. The cascaded axial-flow saltwater crystallization system includes a photothermal salt collection module and a Fresnel salt collection module. The photothermal salt collection module and the Fresnel salt collection module are fixedly disposed side by side on a support frame. The photothermal salt collection module includes a first heat collection tube and a reflector. The first heat collection tube is fixedly disposed on the support frame. The reflector is fixedly disposed below the first heat collection tube. The reflector is configured to, by focusing sunlight to irradiate the first heat collection tube, heat the first heat collection tube. The first heat collection tube is internally provided with a first inner chamber for accommodating saltwater and provided with a water inlet, a salt outlet, and a steam exhaust port. The water inlet, the salt outlet, and the steam exhaust port are connected to the first inner chamber. The Fresnel salt collection module includes a second heat collection tube and a linear Fresnel convex lens. The second heat collection tube is fixedly disposed on the support frame. The linear Fresnel convex lens is fixedly disposed above the second heat collection tube. The linear Fresnel convex lens is configured to, by focusing the sunlight to irradiate the second heat collection tube, heat the second heat collection tube. The second heat collection tube is internally provided with a second inner chamber and provided with a salt inlet and a salt discharge port. The salt inlet and the salt discharge port are connected to the second inner chamber, and the salt outlet is connected to the salt inlet.

In an embodiment, a solenoid valve is disposed on a pipeline connecting the salt outlet to the salt inlet. Axial central lines of the photothermal salt collection module, the solenoid valve, and the Fresnel salt collection module are coaxial. The photothermal salt collection module, the solenoid valve, and the Fresnel salt collection module together form a cascaded axial-flow structure. A first spiral scraper assembly is disposed inside the first heat collection tube, and the first spiral scraper assembly is configured to push materials inside the first heat collection tube into the second heat collection tube. A second spiral scraper assembly is disposed inside the second heat collection tube, and the second spiral scraper assembly is configured to push materials inside the second heat collection tube to the salt discharge port.

In an embodiment, the water inlet of the first heat collection tube is provided at a head end of the first heat collection tube. The water inlet is connected to a saltwater outlet of a heat exchanger through a first pipeline. The heat exchanger is disposed on the support frame. The heat exchanger is provided with a saltwater inlet. A condensed water outlet is disposed on an end of a side wall of the heat exchanger facing toward the saltwater inlet. A steam inlet is disposed on an end of the side wall of the heat exchanger facing toward the saltwater outlet. The steam inlet is connected to the steam exhaust port of the first heat collection tube through a second pipeline. The condensed water outlet is configured for connecting an external water collection pipe.

In an embodiment, the first heat collection tube is disposed inside a first vacuum tube. Two ends of the first heat collection tube extend sealingly out of the first vacuum tube. An inner wall of the first vacuum tube is provided with a one-way light coating layer and a thermal insulation coating layer from inside to outside. A first upper flange is disposed on one of the two ends of the first heat collection tube, and a first lower flange is disposed on the other of the two ends of the first heat collection tube. The first spiral scraper assembly includes a first drive motor and a photothermal salt collection auger fixedly connected to a first rotor provided inside the first drive motor. The first drive motor is internally provided with a first connecting hole. The first rotor is an axial sleeve structure. The photothermal salt collection auger is disposed inside the first heat collection tube along an axial direction of the first heat collection tube and is in movable contact with an inner wall of the first heat collection tube. The photothermal salt collection auger is provided with a first discharge inner hole in an axial direction of the photothermal salt collection auger. An end of a first stator of the first drive motor is fixedly connected to the first upper flange, and another end of the first stator of the first drive motor is fixedly connected to a first pipeline flange of the first pipeline. The first lower flange is fixedly connected to an input end of the solenoid valve.

In an embodiment, the photothermal salt collection auger includes a first spiral blade with an L-shaped cross-section and a first fixed flange fixedly disposed at a head end of the first spiral blade. The first fixed flange is fixedly connected to the first rotor. A first thermal insulation layer is integrally disposed between the first fixed flange and the first rotor and on an inner wall of the first rotor. A first sealing element is disposed on an end of the first thermal insulation layer facing away from the first fixed flange. The first sealing element is configured to seal an interface between the first drive motor and the first pipeline. An outer cylindrical surface of the first sealing element is configured as a structure with multiple annular sealing platforms having a trapezoidal cross-section. The first stator is fixedly and sealingly connected to the first pipeline flange of the first pipeline and the first upper flange.

In an embodiment, the second heat collection tube is disposed inside a second vacuum tube. Two ends of the second heat collection tube extend sealingly out of the second vacuum tube. A spiral heat conductor is disposed between the second heat collection tube and the second vacuum tube, and the spiral heat conductor is sleeved on an outer section of the second heat collection tube. A solution inlet and a solution outlet are respectively provided on an upper end and a lower end of the spiral heat conductor. The solution inlet and the solution outlet penetrate through a side wall of the second heat collection tube. The solution inlet is disposed at a side of the second heat collection tube facing toward the salt inlet. The solution outlet is disposed at a side of the second heat collection tube facing toward the salt discharge port. A second upper flange is disposed on one of the two ends of the second heat collection tube. A second lower flange is disposed on the other one of the two ends of the second heat collection tube. The second upper flange is fixedly connected to an output end of the solenoid valve. The second spiral scraper assembly includes a second drive motor and a Fresnel salt collection auger fixedly connected to a second rotor of the second drive motor. The Fresnel salt collection auger is disposed inside the second heat collection tube along an axial direction of the second heat collection tube and is in movable contact with an inner wall of the second heat collection tube. An end of a second stator of the second drive motor is fixedly connected to the second lower flange, and another end of the second stator is fixedly connected to a third pipeline flange of a third pipeline.

In an embodiment, the Fresnel salt collection auger includes a second spiral blade with a trapezoidal cross-section and a second fixed flange fixedly disposed at a tail end of the Fresnel salt collection auger. The second spiral blade is provided with a second inner hole for material feeding. A cross-section of the second spiral blade gradually decreases along a direction from the salt inlet to the salt discharge port. The second fixed flange is fixedly connected to the second rotor. A second thermal insulation layer is integrally disposed between the second fixed flange and the second rotor and on an inner wall of the second rotor. A second sealing element is disposed on an end of the second thermal insulation layer facing away from the second fixed flange. An outer cylindrical surface of the second sealing element is configured as a structure with multiple annular sealing platforms having a trapezoidal cross-section.

In an embodiment, an output valve is disposed on the salt discharge port. An output end of the third pipeline is connected to a salt collection box. The salt collection box is disposed below the support frame.

In an embodiment, the reflector is fixedly disposed below the first heat collection tube through reflector brackets. The reflector has a strip-shaped parabolic structure, and an inner wall of the reflector is provided with a mirror surface heat insulation reflective coating. A central axis of the first heat collection tube is located at a focal point of the reflector. The linear Fresnel convex lens is fixedly disposed above the second heat collection tube through Fresnel lens brackets. A central axis of the second heat collection tube is located at a focal length of the linear Fresnel convex lens.

In an embodiment, the support frame includes a crossbar, and a left vertical plate and a right vertical plate fixed at both ends of the crossbar. A first middle vertical plate and a second middle vertical plate are symmetrically disposed between the left vertical plate and the right vertical plate. A left heat collection tube installation notch is defined on a top of the left vertical plate. A right heat collection tube installation notch is defined on a top of the right vertical plate. A tail end of the second heat collection tube is fixedly connected to the left vertical plate through the left heat collection tube installation notch. The head end of the first heat collection tube is fixedly connected to the right vertical plate through the right heat collection tube installation notch. A left heat exchanger installation notch is defined on a top of the first middle vertical plate. A right heat exchanger installation notch is defined on a top the second middle vertical plate. A left end of the heat exchanger is fixedly connected to the first middle vertical plate through the left heat exchanger installation notch. A right end of the heat exchanger is fixedly connected to the second middle vertical plate through the right heat exchanger installation notch. The saltwater outlet of the heat exchanger is defined on the right end of the heat exchanger and is connected to the first pipeline through a flange. A right through hole is defined on a middle of the right vertical plate corresponding to the first pipeline. The first pipeline penetrates the right vertical plate through the right through hole to connect the first heat collection tube. A left through hole is defined on the left vertical plate corresponding to the right through hole.

In an embodiment, an output end of a first rotary motor is fixedly connected to a middle of a bottom of the support frame. An input end of the first rotary motor is fixedly connected to an output end of a second rotary motor. An input end of the second rotary motor is fixedly connected to an output end of a third motor. Axes of the first rotary motor, the second rotary motor, and the third rotary motor are perpendicular to each other. The first rotary motor, the second rotary motor, and the third rotary motor together form an orthogonal revolute-revolute-revolute (RRR) three-axis transmission system, thereby enabling spherical movement of the cascaded axial-flow structure and the heat exchanger.

In an embodiment, an input end of the third rotary motor is fixedly connected to a top end of a vertical pole. A bottom end of the vertical pole is fixed on the ground through a flange. The salt collection box is connected to a middle of the vertical pole through throat clamps. The salt collection box is connected to the salt discharge port through the third pipeline. A salt collection port is defined at a bottom of the salt collection box, and a valve is disposed at the salt collection port.

The use method of the cascaded axial-flow saltwater crystallization system includes the following steps:
pumping the saltwater into the heat exchanger for preheating the saltwater to reach a first temperature in a range of 60 degrees Celsius (℃) to 80° C.;
making the saltwater in the heat exchanger enter the first heat collection tube of the photothermal salt collection module;
controlling the first drive motor to rotate in a reverse direction, to thereby drive the photothermal salt collection auger to stir the saltwater in the first heat collection tube, thereby evenly heating the saltwater in the first heat collection tube to reach a second temperature in a range of 85° C. to 160° C. to make water in the saltwater evaporate to generate steam;
discharging the steam generated by evaporation to the heat exchanger through the second pipeline;
preheating newly entered saltwater and condensing the steam inside the heat exchanger;
after heating the saltwater in the first heat collection tube for a first preset duration (usually in a range of 2 minutes to 3 minutes), controlling the first drive motor to rotate in a positive direction, thereby driving the first spiral blade of the photothermal salt collection auger to scrape and convey viscous crystalline salt crystallized inside the first heat collection tube and on the inner wall of the first heat collection tube;
opening the solenoid valve, and outputting, by the photothermal salt collection auger, the viscous crystalline salt to the Fresnel salt collection module;
under cooperation of the linear Fresnel convex lens, the second vacuum tube, and the spiral heat conductor, controlling a temperature of the second heat collection tube to be greater than 200° C.;
controlling the second drive motor to rotate in the reverse direction, thereby driving the Fresnel salt collection auger to stir the viscous crystalline salt, to perform secondary heating and evaporation on the viscous crystalline salt for a second preset duration (usually in a range of 5 minutes to 8 minutes) to generate crystalline salt;
controlling the second drive motor to rotate in the positive direction, thereby driving the second spiral blade to scrape off the crystalline salt adhered to the inner wall of the second heat collection tube; and
outputting the crystalline salt through the third pipeline.

Compared with the related art, the disclosure has the following beneficial effects.
(1) Cascaded axial-flow technology means integrating the photothermal salt collection module and the Fresnel salt collection module provided by the disclosure first heats the saltwater to a set temperature through the photothermal salt collection module and conducts primary crystallization to obtain the viscous crystalline salt. Then, the obtained viscous crystalline salt is conveyed to the Fresnel salt collection module for secondary crystallization. This enables the saltwater to be converted into the crystalline salt with single-end input and single-end output, reducing an original three-phase separation process of water-steam-heat and making a structure of the cascaded axial-flow saltwater crystallization system simpler. By gradually heating the saltwater during a crystallization process, a temperature reached in the cascaded axial-flow saltwater crystallization system is higher than that in a single photothermal salt collection system or a single Fresnel salt collection system, making the crystallization process of the saltwater more efficient, thereby realizing low-energy-consumption resource-based collection of water and salt from the saltwater and solving the problem of high energy consumption and low efficiency of the saltwater evaporation crystallization methods in the art.
(2) By connecting the photothermal salt collection module to the Fresnel salt collection module in series using the solenoid valve to form the cascaded axial-flow structure and combining the first spiral scraper assembly and the second spiral scraper assembly, the crystalline salt in the photothermal salt collection module can be stirred and quickly discharged, and the crystalline salt in the Fresnel salt collection module can be stirred and quickly discharged at the same time. By stirring the crystalline salt in the Fresnel salt collection module, the crystalline salt undergoes recrystallization after the primary crystallization, achieving a full and rapid secondary crystallization, thereby leading to a higher crystallization efficiency.
(3) By collecting the steam to preheat the saltwater using the heat exchanger, the saltwater preheated enters the photothermal salt collection module for the primary crystallization. This reduces a heating duration of the saltwater, shortens a crystallization time, further improves the crystallization efficiency, and realizes energy recovery.
(4) The first vacuum tube is provided with the one-way light coating layer and the thermal insulation coating layer, which can achieve concentration of the sunlight and reduce heat loss, thereby improving an energy utilization rate of the sunlight. The first spiral scraper assembly can ensure that the first drive motor can drive the photothermal salt collection auger to rotate and discharge the crystalline salt while allowing the materials to pass through.
(5) The first spiral blade with the L-shaped cross-section promotes a stirring effect during an evaporation and crystallization process of the saltwater. When outputting the crystalline salt, the first spiral blade can better roll and drive transportation of the crystalline salt (or viscous salt liquid). Moreover, the first spiral blade with the L-shaped cross-section has higher rigidity, higher strength, and higher rotational stability. An L-shaped structure is also more conducive to stirring and transporting the crystalline salt after its formation.
(6) Through disposition of the spiral heat conductor on the second heat collection tube, combined with Fresnel heating, the second heat collection tube can be heated more evenly, a higher temperature can be reached in the second heat connection tube, the saltwater crystallizes faster, the crystallization efficiency is higher, and crystallization is more stable.
(7) The second spiral blade with the trapezoidal cross-section, compared with a blade with a rectangular cross-section, increases a contact area with the crystalline salt. By leveraging a pushing effect of an inclined plane of the trapezoidal cross-section, the second spiral blade further improves a pushing process of the crystalline salt. Moreover, a sharp edge at a smaller end of the trapezoidal cross-section can be utilized to enhance a scraping force of the second spiral blade on the crystalline salt adhered to the inner wall of the second heat collection tube.
(8) By setting the output valve, the crystalline salt can be transported into the salt collection box through the second spiral blade, which facilitates collection and subsequent transportation of the crystalline salt. The first rotary motor, the second rotary motor, and the third rotary motor form the orthogonal RRR three-axis transmission system. Compared with a revolute-revolute (RR) two-axis transmission system of the single photothermal salt collection system or the single Fresnel salt collection system, the orthogonal RRR three-axis transmission system tracks the sunlight more accurately, greatly improving utilization efficiency of solar energy.
(9) When the focal point of the reflector is located on the central axis of the first heat collection tube, and the focal length of the linear Fresnel convex lens is located on the central axis of the second heat collection tube, a heating effect can be maximized, and the utilization efficiency of solar energy can be improved.
(10) The use method of the cascaded axial-flow saltwater crystallization system involves preheating the saltwater to the first temperature in a range of 60° C. to 80° C. through the heat exchanger; supplying the preheated saltwater to the first heat collection tube of the photothermal salt collection module; heating the saltwater to the second temperature in a range of 85° C. to 160° C. for the primary crystallization; and after the saltwater is heated in the first heat collection tube for the first preset duration, transferring the saltwater to the second heat collection tube and heating the saltwater to above 200° C. for the secondary crystallization. This process can improve the crystallization efficiency and enhance the energy utilization rate.
(11) The cascaded axial-flow saltwater crystallization system can utilize the solar energy in nature and adopt a heat collection method driven by a natural force of radiant energy. The cascaded axial-flow saltwater crystallization system can collect heat to evaporate the water in the saltwater resources to generate the steam, then condense the steam and recycle the water; at the same time, the cascaded axial-flow saltwater crystallization system can concentrate, crystallize, and collect the salt in the saltwater resources, realizing the resource-based treatment of water and salt in the saltwater resources and providing beneficial technical support for treatment of the saltwater in saline-alkaline lands in arid regions and coastal areas of China.

To sum up, through the cascaded axial-flow technology means of the heat exchanger, the photothermal salt collection module, and the Fresnel salt collection module, the disclosure condenses and recovers the steam generated by the evaporation of the water in the saltwater, realizing low-energy-consumption resource-based collection of water and salt from the saltwater, thereby solving the problem of high energy consumption and low efficiency of the saltwater evaporation crystallization methods in the art.

Compared with the single photothermal salt collection system or the single Fresnel salt collection system, the disclosure has the following beneficial effects.

Through the cascaded axial-flow technology means, the saltwater is converted into the crystalline salt with a single-end input and a single-end output, reducing the original three-phase separation process of water-steam-heat and making the structure of the cascaded axial-flow saltwater crystallization system simpler.

Using the cascaded axial-flow structure, the saltwater is gradually heated during the crystallization process, the temperature reached in the cascaded axial-flow saltwater crystallization system is higher than that in the single photothermal salt collection system or the single Fresnel salt collection system, making the crystallization process of saltwater more efficient.

Compared with the single Fresnel salt collection system, the spiral heat conductor and the second vacuum tube are additionally disposed outside the second heat collection tube, making the second heat collection tube heated more evenly and the temperature in the second heat collection tube higher.

The first rotary motor, the second rotary motor, and the third rotary motor are additionally disposed to form the orthogonal RRR three-axis transmission system. Compared with the RR two-axis transmission system of the single photothermal salt collection system or the single Fresnel salt collection system, the orthogonal RRR three-axis transmission system tracks the sunlight more accurately, greatly improving the utilization efficiency of solar energy.

The first spiral blade with the L-shaped cross-section is additionally disposed to promote the stirring effect during the evaporation and crystallization process of the saltwater. When outputting the crystalline salt, the first spiral blade can better roll and drive transportation of the crystalline salt (or the viscous salt liquid).

The second spiral blade with the trapezoidal cross-section is additionally disposed. Compared with the blade with the rectangular cross-section, the second spiral blade increases the contact area with the crystalline salt. By leveraging the pushing effect of the inclined plane of the trapezoidal cross-section, the second spiral blade further improves the pushing process of the crystalline salt. Moreover, the sharp edge at the smaller end of the trapezoidal cross-section can be utilized to enhance the scraping force of the second spiral blade on the crystalline salt adhered to the inner wall of the second heat collection tube.

### BRIEF DESCRIPTION OF DRAWINGS

FIG. 1 illustrates a schematic perspective structural view of a cascaded axial-flow saltwater crystallization system according to an embodiment of the disclosure.

FIG. 2 illustrates a side view of the cascaded axial-flow saltwater crystallization system according to the embodiment of the disclosure.

FIG. 3 illustrates a front view of the cascaded axial-flow saltwater crystallization system according to the embodiment of the disclosure.

FIG. 4 illustrates a sectional view of the cascaded axial-flow saltwater crystallization system along a line A-A as illustrated in FIG. 3.

FIG. 5 illustrates a schematic local structural diagram of a first heat collection tube of the cascaded axial-flow saltwater crystallization system according to the embodiment of the disclosure.

FIG. 6 illustrates a schematic structural diagram of a vertical pole and a support frame of the cascaded axial-flow saltwater crystallization system according to the embodiment of the disclosure.

FIG. 7 illustrates a schematic structural diagram of a heat exchanger of the cascaded axial-flow saltwater crystallization system according to the embodiment of the disclosure.

FIG. 8 illustrates a schematic structural diagram of a photothermal salt collection module of the cascaded axial-flow saltwater crystallization system according to the embodiment of the disclosure.

FIG. 9 illustrates a schematic structural diagram of a Fresnel salt collection module of the cascaded axial-flow saltwater crystallization system according to the embodiment of the disclosure.

FIG. 10 illustrates a schematic structural diagram of a spiral heat conductor of the cascaded axial-flow saltwater crystallization system according to the embodiment of the disclosure.

FIG. 11 illustrates an enlarged structural diagram of portion A as illustrated in FIG. 4.

FIG. 12 illustrates an enlarged structural diagram of portion B as illustrated in FIG. 4.

### DETAILED DESCRIPTION OF EMBODIMENTS

The disclosure will be further described with reference to attached drawings of the specification, so as to facilitate better understanding by those skilled in the art.

### Embodiment 1

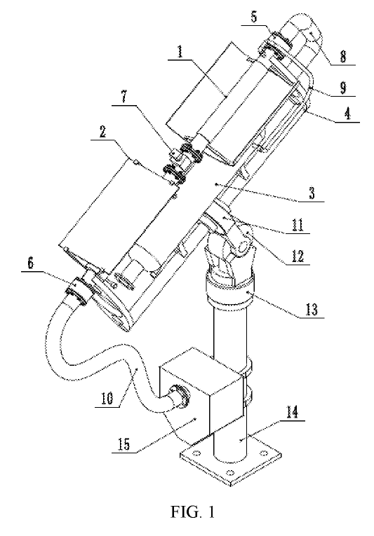

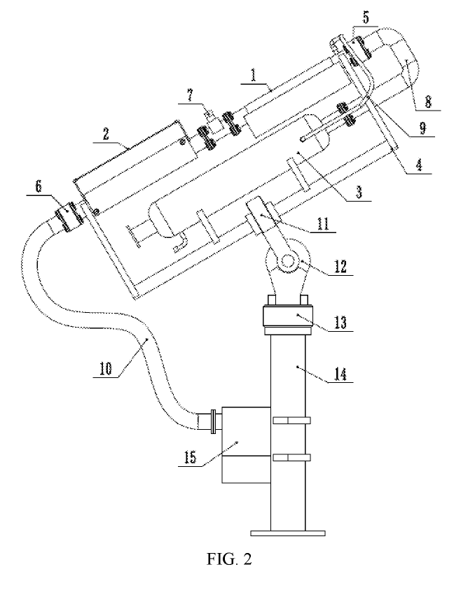

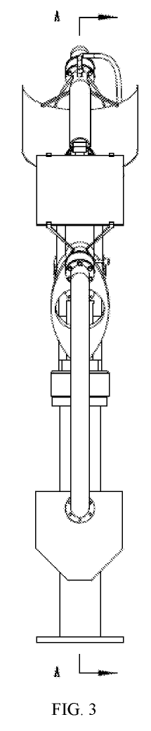

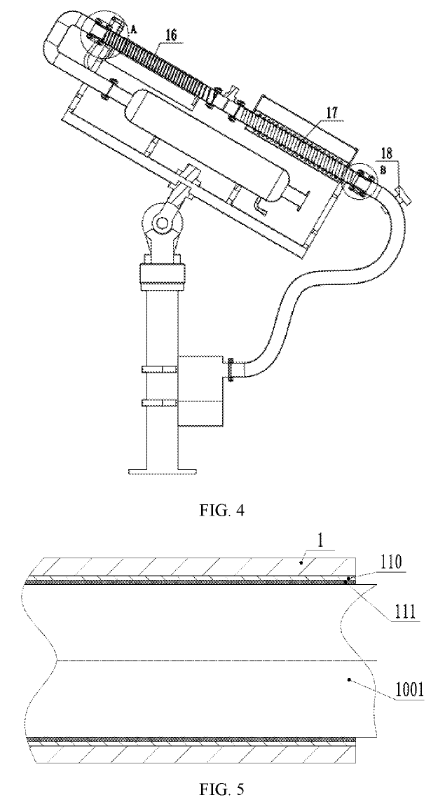

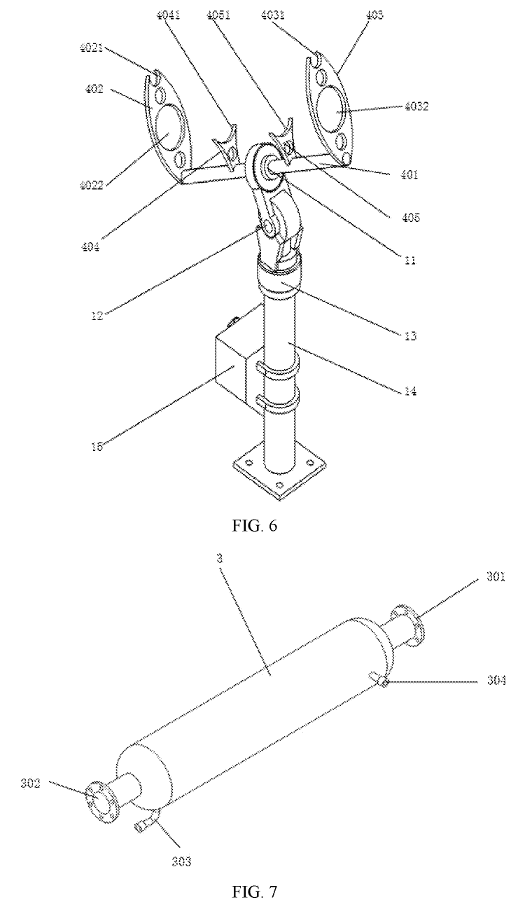

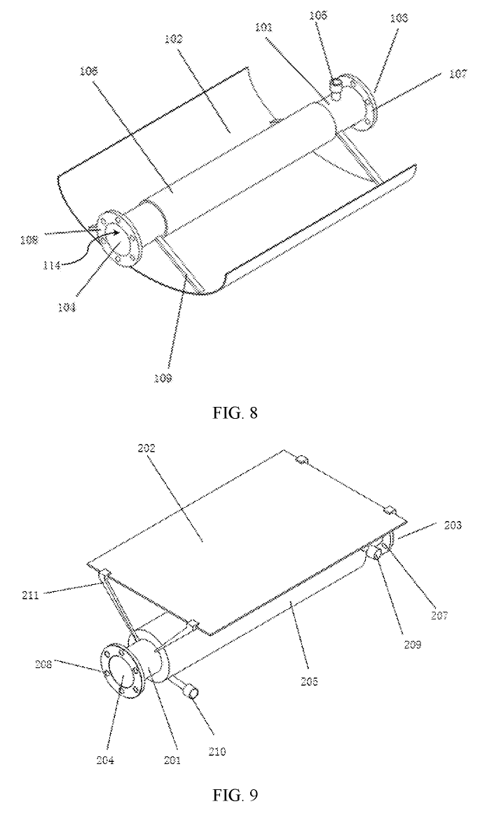

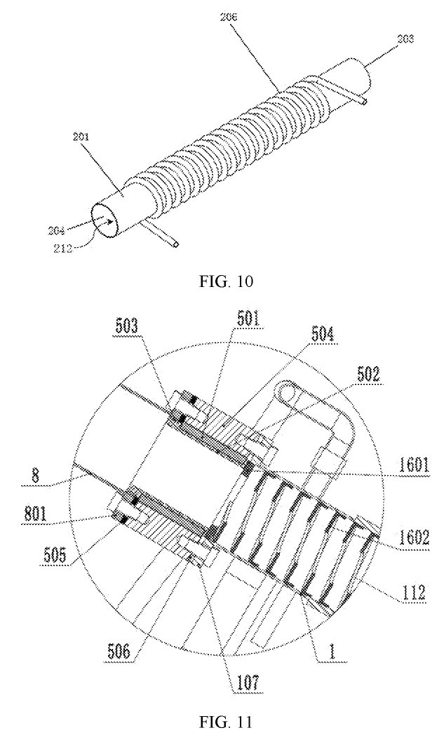

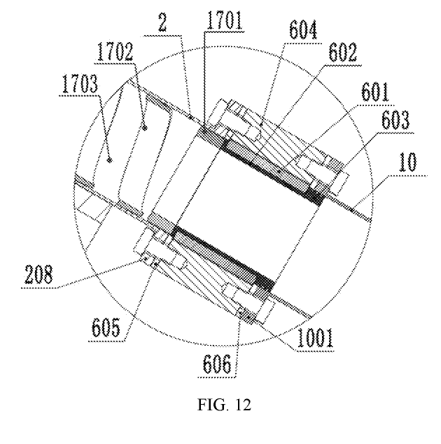

As illustrated in FIGS. 1-12, a cascaded axial-flow saltwater crystallization system includes a photothermal salt collection module 1, a Fresnel salt collection module 2, a heat exchanger 3, a support frame 4, a first drive motor 5, a second drive motor 6, a solenoid valve 7, a first pipeline 8, a second pipeline 9, a third pipeline 10, a first rotary motor 11, a second rotary motor 12, a third rotary motor 13, a vertical pole 14, and a salt collection box 15.

The photothermal salt collection module 1 and the Fresnel salt collection module 2 are fixedly disposed side by side on the support frame 4. The photothermal salt collection module 1 includes a first heat collection tube 101 and a reflector 102. The first heat collection tube 101 is fixedly disposed on the support frame 4, and the reflector 102 is fixedly disposed below the first heat collection tube 101. The reflector 102 is configured to, by focusing sunlight to irradiate the first heat collection tube 101, heat the first heat collection tube 101. The first heat collection tube 101 is internally provided with a first inner chamber 114 for accommodating saltwater and provided with a water inlet 103, a salt outlet 104, and a steam exhaust port 105. The water inlet 103, the salt outlet 104, and the steam exhaust port 105 are connected to the first inner chamber 114. The Fresnel salt collection module 2 includes a second heat collection tube 201 and a linear Fresnel convex lens 202. The second heat collection tube 201 is fixedly disposed on the support frame 4, and the linear Fresnel convex lens 202 is fixedly disposed above the second heat collection tube 201. The linear Fresnel convex lens 202 is configured to, by focusing the sunlight to irradiate the second heat collection tube 201, heat the second heat collection tube 201. The second heat collection tube 201 is internally provided with a second inner chamber 212 and provided with a salt inlet 203 and a salt discharge port 204 connected to the second inner chamber 212. The salt outlet 104 is connected to the salt inlet 203. Cascaded axial-flow technology means integrating the photothermal salt collection module 1 and the Fresnel salt collection module 2 provided by the disclosure first heats the saltwater to a set temperature through the photothermal salt collection module 1 and conducts primary crystallization to obtain viscous crystalline salt. Then, the viscous crystalline salt obtained is conveyed to the Fresnel salt collection module 2 for secondary crystallization. This enables the saltwater to be converted into crystalline salt with a single-end input and a single-end output, reducing an original three-phase separation process of water-steam-heat and making a structure of the cascaded axial-flow saltwater crystallization system simpler. By gradually heating the saltwater during a crystallization process, a temperature reached in the cascaded axial-flow saltwater crystallization system is higher than that in a single photothermal salt collection system or a single Fresnel salt collection system, making the crystallization process of the saltwater more efficient, thereby realizing low-energy-consumption resource-based collection of water and salt from the saltwater and solving a problem of high energy consumption and low efficiency of saltwater evaporation crystallization methods in the art.

The solenoid valve 7 is disposed on a pipeline connecting the salt outlet 104 to the salt inlet 203. Axial central lines of the photothermal salt collection module 1, the solenoid valve 7, and the Fresnel salt collection module 2 are coaxial. The photothermal salt collection module 1, the solenoid valve 7, and the Fresnel salt collection module 2 together form a cascaded axial-flow structure. A first spiral scraper assembly is disposed inside the first heat collection tube 101, and the first spiral scraper assembly is configured to push materials inside the first heat collection tube 101 into the second heat collection tube 201. A second spiral scraper assembly is disposed inside the second heat collection tube 201, and the second spiral scraper assembly is configured to push materials inside the second heat collection tube 201 to the salt discharge port 204. By connecting the photothermal salt collection module 1 to the Fresnel salt collection module 2 in series by using the solenoid valve 7 to form the cascaded axial-flow structure and combining the first spiral scraper assembly and the second spiral scraper assembly, the crystalline salt in the photothermal salt collection module 1 can be stirred and quickly discharged, and the crystalline salt in the Fresnel salt collection module 2 can be stirred and quickly discharged at the same time. By stirring the crystalline salt in the Fresnel salt collection module 2, the crystalline salt undergoes recrystallization after the primary crystallization, achieving a full and rapid secondary crystallization, thereby leading to a higher crystallization efficiency.

The water inlet 103 of the first heat collection tube 101 is provided at a head end of the first heat collection tube 101, and the water inlet 103 is connected to a saltwater outlet 301 of the heat exchanger 3 through the first pipeline 8. The heat exchanger 3 is disposed on the support frame 4, and the heat exchanger 3 is provided with a saltwater inlet 302. A condensed water outlet 303 is disposed on an end of a side wall of the heat exchanger 3 facing toward the saltwater inlet 302. A steam inlet 304 is disposed on an end of the side wall of the heat exchanger 3 facing toward the saltwater outlet 301. The steam inlet 304 is connected to the steam exhaust port 105 of the first heat collection tube 101 through the second pipeline 9. The condensed water outlet 303 is configured for connecting an external water collection pipe. By collecting steam to preheat the saltwater using the heat exchanger 3, the saltwater preheated enters the photothermal salt collection module 1 for the primary crystallization. This reduces a heating duration of the saltwater, shortens a crystallization time, further improves the crystallization efficiency, and realizes energy recovery.

In order to improve a utilization rate of solar energy of the cascaded axial-flow saltwater crystallization system, the reflector 102 is fixedly disposed below the first heat collection tube 101 through reflector brackets 109. The reflector 102 has a strip-shaped parabolic structure, and an inner wall of the reflector 102 is provided with a mirror surface heat insulation reflective coating. A center of the first heat collection tube 101 is located at a focal point of the reflector 102, thereby achieving mirror-based light concentration and maximizing the utilization rate of solar energy. A central axis of the first heat collection tube 101 is located at the focal point of the reflector 102. The first heat collecting tube 101 is made of stainless steel. A first vacuum tube 106 is made of glass. The first heat collection tube 101 is disposed inside the first vacuum tube 106. Two ends of the first heat collection tube 101 extend sealingly out of the first vacuum tube 106. The first heat collection tube 101 and the first vacuum tube 106 are fabricated using a vacuum sintering and sealing process to form a vacuum heat collector. An inner wall of the first vacuum tube 106 is provided with a one-way light coating layer 110 and a thermal insulation coating layer 111 from inside to outside, thereby preventing the sunlight from escaping out of the first vacuum tube 106 and transferring heat to the first heat collection tube 101. A first upper flange 107 is disposed on one of the two ends of the first heat collection tube 101, and a first lower flange 108 is disposed on the other of the two ends of the first heat collection tube 101. The first spiral scraper assembly includes the first drive motor 5 and a photothermal salt collection auger 16 fixedly connected to a first rotor 501 provided inside the first drive motor 5. The first drive motor 5 is internally provided with a first connecting hole. An end of the first drive motor 5 is connected to the first upper flange 107 through a flange, and another end of the first drive motor 5 is connected to the first pipeline 8 through a flange. The first lower flange 108 is connected to an input end of the solenoid valve 7 through a flange. The first rotor 501 is an axial sleeve structure. The photothermal salt collection auger 16 is disposed inside the first heat collection tube 101 along an axial direction of the first heat collection tube 101 and is in movable contact with an inner wall of the first heat collection tube 101. The photothermal salt collection auger 16 is provided with a first discharge inner hole 112 in an axial direction of the photothermal salt collection auger 16. The photothermal salt collection auger 16 includes a first spiral blade 1602 with an L-shaped cross-section and a first fixed flange 1601 fixedly disposed at a head end of the first spiral blade 1602. The first fixed flange 1601 is fixedly connected to the first rotor 501 of the first drive motor 5. The first rotor 501 is used to drive the first fixed flange 1601 and the first spiral blade 1602 to rotate, thereby scraping off the crystalline salt on the inner wall of the first heat collection tube 101 and pushing the crystalline salt toward a tail end of the first heat collection tube 101 to a maximum extent. To protect normal operation of the first rotor 501, a first thermal insulation layer 502 is integrally disposed between the first fixed flange 1601 and the first rotor 501 and on an inner wall of the first rotor 501. A first sealing element 503 is disposed on an end of the first thermal insulation layer 502 facing away from the first fixed flange 1601, and the first sealing element 503 is configured to seal an interface between the first drive motor 5 and the first pipeline 8. An outer cylindrical surface of the first sealing element 503 is configured as a structure with multiple annular sealing platforms having a trapezoidal cross-section, ensuring sealing integrity between the first fixed flange 1601 and the first drive motor 5. To ensure a driving force of the first drive motor 5 on the photothermal salt collection auger 16, an end of a first stator 504 of the first drive motor 5 is fixedly connected to the first upper flange 107, and another end of the first stator 504 of the first drive motor 5 is fixedly connected to a first pipeline flange 801 of the first pipeline 8. The first lower flange 108 is fixedly connected to the input end of the solenoid valve 7. A first sealing gasket 505 is disposed between the first stator 504 and the first pipeline flange 801. A second sealing gasket 506 is disposed between the first stator 504 and the first upper flange 107. The first sealing gasket 505 and the second sealing gasket 506 are fastened with bolts. The first spiral scraper assembly can ensure that the first drive motor 5 can drive the photothermal salt collection auger 16 to rotate and discharge the crystalline salt while allowing the materials to pass through. The first spiral blade 1602 with the L-shaped cross-section promotes a stirring effect during an evaporation and crystallization process of the saltwater. When outputting the crystalline salt, the first spiral blade 1602 can better roll and drive transportation of the crystalline salt (or viscous salt liquid). Moreover, the first spiral blade 1602 with the L-shaped cross-section has higher rigidity, higher strength, and higher rotational stability. An L-shaped structure is also more conducive to stirring and transporting the crystalline salt after its formation.

The linear Fresnel convex lens 202 is fixedly disposed above the second heat collection tube 201 through Fresnel lens brackets 211. A center of the second heat collection tube 201 is disposed at a focal length of the linear Fresnel convex lens 202 to improve the utilization rate of solar energy. The second heat collection tube 201 is made of stainless steel, and a second vacuum tube 205 is made of glass. The second heat collection tube 201 is disposed inside the second vacuum tube 205. Two ends of the second heat collection tube 201 extend sealingly out of the second vacuum tube 205. The second heat collection tube 201 and the second vacuum tube 206 are fabricated using the vacuum sintering and sealing process. A spiral heat conductor 206 is disposed between the second heat collection tube 201 and the second vacuum tube 205, and the spiral heat conductor 206 is sleeved on an outer section of the second heat collection tube 201. A solution inlet 209 and a solution outlet 210 are respectively provided on an upper end and a lower end of the spiral heat conductor 206. The solution inlet 209 and the solution outlet 210 penetrate through a side wall of the second heat collection tube 202. The solution inlet 209 is disposed at a side of the second heat collection tube 201 facing toward the salt inlet 203, and the solution outlet 210 is disposed at a side of the second heat collection tube 201 facing toward the salt discharge port 204. Disposition of the spiral heat conductor 206 on the second heat collection tube 201, combined with Fresnel heating, allows the second heat collection tube 201 to be heated more evenly, a higher temperature to be reached, the saltwater to crystallize faster, the crystallization efficiency to be higher, and crystallization to be more stable.

A second upper flange 207 is disposed on one of the two ends of the second heat collection tube 201, and a second lower flange 208 is disposed on the other of the two ends of the second heat collection tube 201. The second upper flange 207 is fixedly connected to an output end of the solenoid valve 7. The second spiral scraper assembly includes a second drive motor 6 and a Fresnel salt collection auger 17 fixedly connected to a second rotor 601 of the second drive motor 6. The second drive motor 6 is fixedly connected to the second lower flange 208. The Fresnel salt collection auger 17 is disposed inside the second heat collection tube 201 along an axial direction of the second heat collection tube 201 and is in movable contact with an inner wall of the second heat collection tube 201. The Fresnel salt collection auger 17 includes a second spiral blade 1702 with a trapezoidal cross-section and a second fixed flange 1701 fixedly disposed at a tail end of the second spiral blade 1702. The second spiral blade 1702 is provided with a second inner hole 1703 for material feeding. A cross-section of the second spiral blade 1702 gradually decreases along a direction from the salt inlet 203 to the salt discharge port 204. The second spiral blade 1702 with the trapezoidal cross-section, compared with a blade with a rectangular cross-section, increases a contact area with the crystalline salt. By leveraging a pushing effect of an inclined plane of the trapezoidal cross-section, the second spiral blade 1702 further improves a pushing process of the crystalline salt. Moreover, a sharp edge at a smaller end of the trapezoidal cross-section can be utilized to enhance a scraping force of the second spiral blade 1702 on the crystalline salt adhered to the inner wall of the second heat collection tube 201. The second fixed flange 1702 is fixedly connected to the second rotator 601 of the second drive motor 6. The second rotor 601 is used to drive the second fixed flange 1701 and the second spiral blade 1702 to rotate, thereby scraping off the crystalline salt on the inner wall of the second heat collection tube 201 and pushing the crystalline salt toward the salt discharge port 204 to a maximum extent. To avoid high-temperature deformation of the second rotor 601 affecting operation, a second thermal insulation layer 602 is integrally disposed between the second fixed flange 1701 and the second rotor 601 and on an inner wall of the second rotor 601. A second sealing element 603 is disposed on an end of the second thermal insulation layer 602 facing away from the second fixed flange 1701, and the second sealing element 603 is configured to elastically seal an interface between the salt discharge port 204 and the second rotor 601. An outer cylindrical surface of the second sealing element 603 is configured as a structure with multiple annular sealing platforms having a trapezoidal cross-section. An end of a second stator 604 of the second drive motor 6 is fixedly connected to the second lower flange 208, and another end of the second stator 604 is fixedly connected to a third pipeline flange 1001 of the third pipeline 10. A third sealing gasket 605 is disposed between the second stator 604 and the second lower flange 208. A fourth sealing gasket 606 is disposed between the second stator 604 and the third pipeline flange 1001. The third sealing gasket 605 and the fourth sealing gasket 606 are fastened with the bolts.

The salt discharge port 204 of the second heat collection tube 201 is defined at a tail end of the second heat collection tube 201. An output valve 18 is disposed on the salt discharge port 204. The output valve 18 is used to seal the second heat collection tube 201 during crystallization of the saltwater. The salt discharge port 204 is fixedly connected to an end of the second drive motor 6, and another end of the second drive motor 6 is connected to the third pipeline 10. An output end of the third pipeline 10 is connected to the salt collection box 15. The salt collection box 15 is disposed below the support frame 4. Through the output valve 18, the crystalline salt can be transported into the salt collection box 15 by the second spiral blade 1702, facilitating collection and subsequent transportation of the crystalline salt. The solution inlet 209 is disposed on an end of the side wall of the second heat collection tube 201 facing toward the salt inlet 203. The solution outlet 211 is disposed on an end of the side wall of the second heat collection tube 201 facing toward the salt discharge port 204. Clean water can be pressed into the second heat collection tube 201 through the solution inlet 209 for flushing and then flow out from the solution outlet 211. During use, both the solution inlet 209 and the solution outlet 211 are sealed.

In the embodiment, the support frame 4 includes a crossbar 401, and a left vertical plate 402 and a right vertical plate 403 fixed at both ends of the crossbar 401. A first middle vertical plate 404 and a second middle vertical plate 405 are disposed between the left vertical plate 402 and the right vertical plate 403. The first middle vertical plate 404 and the second middle vertical plate 405 are axially symmetric about a center of the crossbar 401. A left heat collection tube installation notch 4021 is defined on a top of the left vertical plate 402. A right heat collection tube installation notch 4031 is defined on a top of the right vertical plate 403. The tail end of the second heat collection tube 201 is fixedly connected to the left vertical plate 402 through the left heat collection tube installation notch 4021. The head end of the first heat collection tube 101 is fixedly connected to the right vertical plate 403 through the right heat collection tube installation notch 4031. A left heat exchanger installation notch 4041 is defined on a top of the first middle vertical plate 404. A right heat exchanger installation notch 4051 is defined on a top the second middle vertical plate 405. A left end of the heat exchanger 3 is fixedly connected to the first middle vertical plate 404 through the left heat exchanger installation notch 4041. A right end of the heat exchanger 3 is fixedly connected to the second middle vertical plate 405 through the right heat exchanger installation notch 4051. The saltwater outlet 301 of the heat exchanger 3 is defined on the right end of the heat exchanger 3 and is connected to the first pipeline 8 through a flange. A right through hole 4032 is defined on a middle of the right vertical plate 403 corresponding to the first pipeline 8. The first pipeline 8 penetrates the right vertical plate 403 through the right through hole 4032 to connect the first drive motor 5. A left through hole 4022 is defined on the left vertical plate 402 corresponding to the right through hole 4032.

A middle part of the crossbar 401 of the support frame 4 is fixedly connected to an output end of the first rotary motor 11. The first rotary motor 11 drives the support frame 4 to swing left and right. An input end of the first rotary motor 11 is fixedly connected to an output end of the second rotary motor 12. The second rotary motor 12 drives the first rotary motor 11 and the support frame 4 to perform pitching motion. An input end of the second rotary motor 12 is fixedly connected to an output end of the third rotary motor 13, and the third rotary motor 13 performs a rotating motion. Axes of the first rotary motor 11, the second rotary motor 12, and the third rotary motor 13 are perpendicular to each other, and the first rotary motor 11, the second rotary motor 12, and the third rotary motor 13 together form an orthogonal RRR three-axis transmission system, thereby enabling spherical movement of the cascaded axial-flow structure and the heat exchanger 3. The orthogonal RRR three-axis transmission system formed by the first rotary motor 11, the second rotary motor 12, and the third rotary motor 13, compared with an RR two-axis transmission system of the single photothermal salt collection system or the single Fresnel salt collection system, tracks the sunlight more accurately, greatly improving the utilization efficiency of solar energy.

Specifically, a light-sensing tracking system is disposed on the support frame 4. The light-sensing tracking system includes a sensing unit and a control unit. The sensing unit is used to collect parameters such as rotation angle, pitch angle, wind speed, temperature, humidity, and light intensity. The control unit receives data from the sensing unit, controls movement of the orthogonal RRR three-axis transmission system, and adjusts the cascaded axial-flow structure to an optimal posture.

In the embodiment, an input end of the third rotary motor 13 is fixedly connected to a top end of the vertical pole 14. A bottom end of the vertical pole 14 is fixed on the ground through a flange. The salt collection box 15 is connected to a middle of the vertical pole 14 through throat clamps. The salt collection box 15 is connected to the salt discharge port 204 through the third pipeline 10.

### Embodiment 2

A use method of the cascaded axial-flow saltwater crystallization system includes the following steps. The saltwater is pumped into the heat exchanger 3 for preheating to reach a first temperature in a range of 60° C. to 80° C. The saltwater in the heat exchanger 3 with a temperature in the range of 60° C. to 80° C. is made to enter the first heat collection tube 101 of the photothermal salt collection module 1. The first drive motor 5 is controlled to rotate in a reverse direction to thereby drive the photothermal salt collection auger 16 to stir the saltwater in the first heat collection tube 101, thereby evenly heating the saltwater in the first heat collection tube 101 to reach a second temperature in a range of 85° C. to 160° C. to make water in the saltwater evaporate to generate steam. The steam is discharged to the heat exchanger 3 through the second pipeline 9. Newly entered saltwater is preheated and the steam is condensed inside the heat exchanger 3. After the saltwater in the first heat collection tube 101 is heated for a first preset duration (usually in a range of 2 minutes to 3 minutes), the first drive motor 5 is controlled to rotate in a positive direction, thereby driving the first spiral blade 1602 of the photothermal salt collection auger 16 to scrape and convey viscous crystalline salt crystallized inside the first heat collection tube 101 and on the inner wall of the first heat collection tube 101. The solenoid valve 7 is opened, and the viscous crystalline salt is outputted by the photothermal salt collection auger 16 to the Fresnel salt collection module 2. Under cooperation of the linear Fresnel convex lens 202, the second vacuum tube 205, and the spiral heat conductor 206, a temperature inside the second heat collection tube 201 is controlled to be greater than 200° C., and a pressure is controlled to be 80 kilopascals (kPa). The second drive motor 6 is controlled to rotate in the reverse direction, thereby driving the Fresnel salt collection auger 17 to stir the viscous crystalline salt, to perform secondary heating and evaporation on the viscous crystalline salt for a second preset duration (usually in a range of 5 minutes to 8 minutes) to generate the crystalline salt. The second drive motor 6 is controlled to rotate in the positive direction, thereby driving the second spiral blade 1702 to scrape off the crystalline salt adhered to the inner wall of the second heat collection tube 201. The crystalline salt is output through the third pipeline 10.

The use method of the cascaded axial-flow saltwater crystallization system involves preheating the saltwater to the range of 60° C. to 80° C. through the heat exchanger 3; supplying the preheated saltwater to the first heat collection tube 101 of the photothermal salt collection module 1; heating the saltwater to the range of 85° C. to 160° C. for the primary crystallization; and after the saltwater in the first heat collection tube 101 is heated for the first preset duration, transferring the saltwater to the second heat collection tube 201 and heating the saltwater to above 200° C. for secondary crystallization. This process can improve the crystallization efficiency and enhance the utilization rate of solar energy.

The embodiments described above are only some embodiments of the disclosure and do not limit a scope of protection of the disclosure. Without departing from a design spirit and principles of the disclosure, various modifications and improvements made to technical solutions of the disclosure by those skilled in the art shall fall within the scope of protection determined by the claims of the disclosure.

What is claimed is:

1. A cascaded axial-flow saltwater crystallization system, comprising a photothermal salt collection module (1) and a Fresnel salt collection module (2), wherein the photothermal salt collection module (1) and the Fresnel salt collection module (2) are fixedly disposed side by side on a support frame (4);
wherein the photothermal salt collection module (1) comprises a first heat collection tube (101) and a reflector (102); the first heat collection tube (101) is fixedly disposed on the support frame (4), and the reflector (102) is fixedly disposed below the first heat collection tube (101); the reflector (102) is configured to, by focusing sunlight to irradiate the first heat collection tube (101), heat the first heat collection tube (101); the first heat collection tube (101) is internally provided with a first inner chamber (114) for accommodating saltwater and provided with a water inlet (103), a salt outlet (104), and a steam exhaust port (105), and the water inlet (103), the salt outlet (104), and the steam exhaust port (105) are connected to the first inner chamber (114); and
wherein the Fresnel salt collection module (2) comprises a second heat collection tube (201) and a linear Fresnel convex lens (202); the second heat collection tube (201) is fixedly disposed on the support frame (4), and the linear Fresnel convex lens (202) is fixedly disposed above the second heat collection tube (201); and the linear Fresnel convex lens (202) is configured to, by focusing the sunlight to irradiate the second heat collection tube (201), heat the second heat collection tube (201); the second heat collection tube (201) is internally provided with a second inner chamber (212) and provided with a salt inlet (203) and a salt discharge port (204), the salt inlet (203) and the salt discharge port (204) are connected to the second inner chamber (212), and the salt outlet (104) is connected to the salt inlet (203).

2. The cascaded axial-flow saltwater crystallization system as claimed in claim 1, wherein a solenoid valve (7) is disposed on a pipeline connecting the salt outlet (104) to the salt inlet (203); axial central lines of the photothermal salt collection module (1), the solenoid valve (7), and the Fresnel salt collection module (2) are coaxial, and the photothermal salt collection module (1), the solenoid valve (7), and the Fresnel salt collection module (2) together form a cascaded axial-flow structure; and
wherein a first spiral scraper assembly is disposed inside the first heat collection tube (101), and the first spiral scraper assembly is configured to push materials inside the first heat collection tube (101) into the second heat collection tube (201); a second spiral scraper assembly is disposed inside the second heat collection tube (201), and the second spiral scraper assembly is configured to push materials inside the second heat collection tube (201) to the salt discharge port (204).

3. The cascaded axial-flow saltwater crystallization system as claimed in claim 1, wherein the water inlet (103) of the first heat collection tube (101) is provided at a head end of the first heat collection tube (101), and the water inlet (103) is connected to a saltwater outlet (301) of a heat exchanger (3) through a first pipeline (8); the heat exchanger (3) is disposed on the support frame (4), and the heat exchanger (3) is provided with a saltwater inlet (302); a condensed water outlet (303) is disposed on an end of a side wall of the heat exchanger (3) facing toward the saltwater inlet (302), and a steam inlet (304) is disposed on an end of the side wall of the heat exchanger (3) facing toward the saltwater outlet (301); and the steam inlet (304) is connected to the steam exhaust port (105) of the first heat collection tube (101) through a second pipeline (9), and the condensed water outlet (303) is configured for connecting an external water collection pipe.

4. The cascaded axial-flow saltwater crystallization system as claimed in claim 2, wherein the first heat collection tube (101) is disposed inside a first vacuum tube (106), and two ends of the first heat collection tube (101) extend sealingly out of the first vacuum tube (106); and an inner wall of the first vacuum tube (106) is provided with a one-way light coating layer (110) and a thermal insulation coating layer (111) from inside to outside; a first upper flange (107) is disposed on one of the two ends of the first heat collection tube (101), and a first lower flange (108) is disposed on the other of the two ends of the first heat collection tube (101);
wherein the first spiral scraper assembly comprises a first drive motor (5) and a photothermal salt collection auger (16) fixedly connected to a first rotor (501) provided inside the first drive motor (5); the first rotor (501) is an axial sleeve structure; the photothermal salt collection auger (16) is disposed inside the first heat collection tube (101) along an axial direction of the first heat collection tube (101) and is in movable contact with an inner wall of the first heat collection tube (101); and the photothermal salt collection auger (16) is provided with a first discharge inner hole (112) in an axial direction of the photothermal salt collection auger (16); and
wherein an end of a first stator (504) of the first drive motor (5) is fixedly and sealingly connected to the first upper flange (107), and another end of the first stator (504) of the first drive motor (5) is fixedly and sealingly connected to a first pipeline flange (801) of a first pipeline (8); and the first lower flange (108) is fixedly connected to an input end of the solenoid valve (7).

5. The cascaded axial-flow saltwater crystallization system as claimed in claim 4, wherein the photothermal salt collection auger (16) comprises a first spiral blade (1602) with an L-shaped cross-section and a first fixed flange (1601) fixedly disposed at a head end of the first spiral blade (1602); the first fixed flange (1601) is fixedly connected to the first rotor (501); a first thermal insulation layer (502) is integrally disposed between the first fixed flange (1601) and the first rotor (501) and on an inner wall of the first rotor (501); a first sealing element (503) is disposed on an end of the first thermal insulation layer (502) facing away from the first fixed flange (1601), and the first sealing element (503) is configured to seal an interface between the first drive motor (5) and the first pipeline (8); and an outer cylindrical surface of the first sealing element (503) is configured as a structure with multiple annular sealing platforms having a trapezoidal cross-section.

6. The cascaded axial-flow saltwater crystallization system as claimed in claim 5, wherein the second heat collection tube (201) is disposed inside a second vacuum tube (205), and two ends of the second heat collection tube (201) extend sealingly out of the second vacuum tube (205); a spiral heat conductor (206) is disposed between the second heat collection tube (201) and the second vacuum tube (205), and the spiral heat conductor (206) is sleeved on an outer section of the second heat collection tube (201); a solution inlet (209) and a solution outlet (210) are respectively provided on an upper end and a lower end of the spiral heat conductor (206), the solution inlet (209) and the solution outlet (210) penetrate through a side wall of the second heat collection tube (201), the solution inlet (209) is disposed at a side of the second heat collection tube (201) facing toward the salt inlet (203), and the solution outlet (210) is disposed at a side of the second heat collection tube (201) facing toward the salt discharge port (204);
wherein a second upper flange (207) is disposed on one of the two ends of the second heat collection tube (201), and a second lower flange (208) is disposed on the other of the two ends of the second heat collection tube (201); and the second upper flange (207) is fixedly connected to an output end of the solenoid valve (7); and
wherein the second spiral scraper assembly comprises a second drive motor (6) and a Fresnel salt collection auger (17) fixedly connected to a second rotor (601) of the second drive motor (6); the Fresnel salt collection auger (17) is disposed inside the second heat collection tube (201) along an axial direction of the second heat collection tube (201) and is in movable contact with an inner wall of the second heat collection tube (201); and an end of a second stator (604) of the second drive motor (6) is fixedly connected to the second lower flange (208), and another end of the second stator (604) is fixedly connected to a third pipeline flange (1001) of a third pipeline (10).

7. The cascaded axial-flow saltwater crystallization system as claimed in claim 6, wherein the Fresnel salt collection auger (17) comprises a second spiral blade (1702) with a trapezoidal cross-section and a second fixed flange (1701) fixedly disposed at a tail end of the second spiral blade (1702); the second spiral blade (1702) is provided with a second inner hole (1703) for material feeding; a cross-section of the second spiral blade (1702) gradually decreases along a direction from the salt inlet (203) to the salt discharge port (204); the second fixed flange (1701) is fixedly connected to the second rotor (601); a second thermal insulation layer (602) is integrally disposed between the second fixed flange (1701) and the second rotor (601) and on an inner wall of the second rotor (601); a second sealing element (603) is disposed on an end of the second thermal insulation layer (602) facing away from the second fixed flange (1701), and the second sealing element (603) is configured to elastically seal an interface between the salt discharge port (204) of the second heat collection pipe (201) and the second rotor (601); and an outer cylindrical surface of the second sealing element (603) is configured as a structure with multiple annular sealing platforms having a trapezoidal cross-section.

8. The cascaded axial-flow saltwater crystallization system as claimed in claim 6, wherein an output valve (18) is disposed on the salt discharge port (204); an output end of the third pipeline (10) is connected to a salt collection box (15), and the salt collection box (15) is disposed below the support frame (4); an output end of a first rotary motor (11) is fixedly connected to a middle of a bottom of the support frame (4), an input end of the first rotary motor (11) is fixedly connected to an output end of a second rotary motor (12), and an input end of the second rotary motor (12) is fixedly connected to an output end of a third motor (13); axes of the first rotary motor (11), the second rotary motor (12), and the third rotary motor (13) are perpendicular to each other; and the first rotary motor (11), the second rotary motor (12), and the third rotary motor (13) together form an orthogonal revolute-revolute-revolute (RRR) three-axis transmission system, thereby enabling spherical movement of the cascaded axial-flow structure and a heat exchanger (3).

9. The cascaded axial-flow saltwater crystallization system as claimed in claim 1, wherein the reflector (102) is fixedly disposed below the first heat collection tube (101) through reflector brackets (109); the reflector (102) has a strip-shaped parabolic structure, and an inner wall of the reflector (102) is provided with a mirror surface heat insulation reflective coating; and a central axis of the first heat collection tube (101) is located at a focal point of the reflector (102); and
wherein the linear Fresnel convex lens (202) is fixedly disposed above the second heat collection tube (201) through Fresnel lens brackets (211), and a central axis of the second heat collection tube (201) is disposed at a focal length of the linear Fresnel convex lens (202).

10. A use method of the cascaded axial-flow saltwater crystallization system as claimed in claim 6, wherein the use method comprises the following steps:
pumping the saltwater into a heat exchanger (3) for preheating the saltwater to reach a first temperature in a range of 60 degrees Celsius (℃) to 80℃;
making the saltwater in the heat exchanger (3) enter the first heat collection tube (101) of the photothermal salt collection module (1);
controlling the first drive motor (5) to rotate in a reverse direction, thereby driving the photothermal salt collection auger (16) to stir the saltwater in the first heat collection tube (101), thereby evenly heating the saltwater in the first heat collection tube (101) to reach a second temperature in a range of 85℃ to 160℃ to make water in the saltwater evaporate to generate steam;
discharging the steam generated by evaporation to the heat exchanger (3) through a second pipeline (9);
preheating newly entered saltwater and condensing the steam inside the heat exchanger (3);
after heating the saltwater in the first heat collection tube (101) for a first preset duration, controlling the first drive motor (5) to rotate in a positive direction, thereby driving the first spiral blade (1602) of the photothermal salt collection auger (16) to scrape and convey viscous crystalline salt crystallized inside the first heat collection tube (101) and on the inner wall of the first heat collection tube (101);
opening the solenoid valve, and outputting, by the photothermal salt collection auger (16), the viscous crystalline salt to the Fresnel salt collection module (2);
under cooperation of the linear Fresnel convex lens (202), the second vacuum tube (205), and the spiral heat conductor (206), controlling a temperature inside the second heat collection tube (201) to be greater than 200℃;
controlling the second drive motor (6) to rotate in the reverse direction, thereby driving the Fresnel salt collection auger (17) to stir the viscous crystalline salt, to perform secondary heating and evaporation on the viscous crystalline salt for a second preset duration to generate crystalline salt;
controlling the second drive motor (6) to rotate in the positive direction, thereby driving a second spiral blade (1702) to scrape off the crystalline salt adhered to the inner wall of the second heat collection tube (201); and
outputting the crystalline salt through the third pipeline (10).
